(19) United States
(12) Patent Application Publication
(10) Pub. No.: US 2008/0316331 A1
(43) Pub. Date: Dec. 25, 2008

(54) Image processing apparatus and method for displaying captured image without time delay and computer readable medium stored thereon computer executable instructions for performing the method

(75) Inventor: Sung-Chun Jun, Seoul (KR)

Correspondence Address: JONES DAY, 222 EAST 41ST ST, NEW YORK, NY, 10017, US

(73) Assignee: Core Logic, Inc.

(21) Appl. No.: 12/215,201

(22) Filed: Jun. 25, 2008

(30) Foreign Application Priority Data
Jun. 25, 2007 (KR) 10-2007-0062391
Jun. 25, 2007 (KR) 10-2007-0062392
Jun. 25, 2007 (KR) 10-2007-0062393

(51) Int. Cl. H04N 5/228

(52) U.S. Cl. 348/222.1; 348/E05.031

(57) ABSTRACT

The present invention provides image processing apparatus and method for displaying a captured image without a time delay. According to the present invention, an image signal processing module outputs sequentially an image data for display and an image data for storage of a captured image to a multimedia application processing module, and the multimedia application processing module stores the image data for storage into a memory and displays the image data for display on a display means. The image data for display is already processed in conformity with format of the display means by the image signal processing module, and in particular, a separate encoding is not performed on the image data for display, and thus the multimedia application processing module can directly display the captured image on the display means without a time delay.

### CLAIM OF PRIORITY

This application claims priority under 35 USC §119(a) to Korean Patent Application Nos. 10-2007-0062391, 10-2007-0062392 and 10-2007-0062393, all filed on Jun. 25, 2007, in the Korean Intellectual Property Office, the entire contents of which are hereby incorporated by reference.

### TECHNICAL FIELD

The present invention relates to image processing, and in particular, to image processing apparatus and method which can display a captured image without a time delay.

### BACKGROUND

Recently, a digital camera using an image sensor such as CCD (Charge Coupled Device) or CMOS (Complementary Metal-Oxide Semiconductor) is widely spread and used. The digital camera is commercialized as a camera-only-product, and besides is mounted in a hand-held terminal such as a mobile phone or PDA (Personal Digital Assistant).

However, a central processing unit of the hand-held terminal does not have as good a clock speed and memory capacity as that of a personal computer. And, development trends of the hand-held terminal move toward thickness and size reduction of the terminal. In this context, the terminal has a spatial limitation in mounting an additional device such as a camera. Meanwhile, in spite of such a spatial limitation, a digital camera mounted in the hand-held terminal moves toward higher pixel, for example three million pixels. Accordingly, an image processing apparatus should process many amount of data in a short time under a spatial limitation.

A general image processing apparatus comprises an image sensor for picking up an image, an image signal processing module for converting an analog raw image data received from the image sensor into a digital data and processing the digital data in conformity with format of a general image data, a multimedia application processing module for storing the image data received from the image data processing module into a storage medium and displaying the image, and a display means such as a view finder for displaying a preview image or a captured image. Generally, the image sensor, the image signal processing module and the multimedia application processing module each is incorporated into a chip, and is mounted in the image processing apparatus (a digital camera or a hand-held terminal) together with for example, an LCD (Liquid Crystal Display) module of the display means.

The image processing apparatus is operated such that an analog raw image data taken by the image sensor is converted into a digital data by the image signal processing module, and the digital data is converted into an image data suitable for a general image format through preprocessing such as color correction, gamma correction or color coordinate conversion. The digital image data converted by the image signal processing module is transmitted to the multimedia application processing module, and the multimedia application processing module encodes the received image data according to a predetermined standard such as JPEG (Joint Photographic Experts Group) encoding, stores the encoded image data into a memory such as SDRAM (Synchronous DRAM), decodes the image data stored in the memory and displays the decoded image data on the display means.

However, as the number of pixels of a digital camera mounted in a hand-held terminal increases, the amount of data to be processed by the multimedia application processing module increases. Consequently, a processing speed of the multimedia application processing module does not keep up with the increased amount of data. For example, according to a high pixel photographing apparatus of three million pixels or more, when the multimedia application processing module encodes and stores an image data that is inputted at a high speed of 10 frames or more per second and displays the image data on the display means, an image data of a next frame may be inputted while an image data of a frame is being encoded. In this case, data collision may occur, thereby causing instability of high speed data interface. To solve the problem, a clock frequency of the multimedia application processing module could be increased considerably, however it is not always technically possible to do so. Conventionally, a clock frequency of the image signal processing module was decreased in accord with limitation of a clock frequency of the multimedia application processing module, which resulted in reduced image quality.

Meanwhile, as another solution to the problem, encoding by the multimedia application processing module was performed by the image signal processing module. That is, the image signal processing module is provided with a preprocessing block for conversion or correction as originally performed and an encoding unit, and thus the image signal processing module encodes a captured image captured by the image sensor. In the case that an image data of a next frame is inputted while an image data of a frame is being encoded, the image data of a next frame is skipped or a vertical synchronization signal (V_sync) representing an input start of a next frame is delayed, thereby preventing data collision that may occur during encoding. Meanwhile, the image data encoded by the image signal processing module is transmitted to the multimedia application processing module and stored into a memory, or is decoded and displayed on the display means.

However, according to the above-mentioned conventional method, before the captured image is displayed on the display means by the multimedia application processing module, the captured image should be decoded and downscaled in conformity with definition of the display means that is lower than that of an image stored by a general method. Consequently, it requires considerable time to display the captured image. Accordingly, the conventional method can solve the unstable data interface problem caused by high pixel, but cannot meet the demands for prompt check of the captured image and rapid capture of a next image. In particular, because the captured image is displayed slowly, image capture and display is delayed in a continuous capture mode in which images are captured continuously in a short time. As a result, unnaturalness of a resultant image is noticeable, which makes commercialization of an image processing apparatus awkward.

### SUMMARY

The present invention was devised to solve the above-mentioned problems. An object of the present invention is to provide an image processing apparatus, which can solve instability of high speed data interface caused by high pixel and display rapidly a captured image.

Another object of the present invention is to provide an image processing method, which can solve instability of high speed data interface caused by high pixel and display rapidly a captured image.

Still another object of the present invention is to provide a computer readable medium stored thereon computer executable instructions for performing the image processing method capable of displaying a captured image rapidly.

These and other features, aspects, and advantages of the present invention will be more fully described in the preferred embodiments of the present invention. And, the objects and advantages of the present invention can be implemented by configurations recited in the claims singularly or in combination.

To achieve the above-mentioned objects, in the present invention, an image signal processing module outputs sequentially an image data for display and an image data for storage of a captured image to a multimedia application processing module, so that the multimedia application processing module stores the image data for storage into a memory and displays the image data for display on a display means. The image data for display is already processed in conformity with format of the display means by the image signal processing module, and thus the multimedia application processing module does not need a separate operation for displaying the captured image on the display means, but just displays the image data for display on the display means as it is. Therefore, the captured image is displayed without a time delay.

Specifically, an image processing apparatus according to an aspect of the present invention comprises an image signal processing module including an original image processing unit for processing a captured image captured by an image sensor in conformity with a preset format of an image data for storage; a display image processing unit for processing the captured image in conformity with format of a display means; and an image output unit for outputting a first image data processed by the original image processing unit and a second image data processed in the display image processing unit, and a multimedia application processing module for storing the first image data outputted by the image output unit into a memory and displaying the second image data outputted by the image output unit on the display means.

And, an image processing method according to another aspect of the present invention that is performed in a capture mode by an image processing apparatus including an image sensor, an image signal processing module, a multimedia application processing module and a display means, comprises (a) the image signal processing module processing a captured image captured by the image sensor in conformity with a preset format of an image data for storage; (b) the image signal processing module processing the captured image in conformity with format of the display means; and (c) the image signal processing module outputting sequentially an image data processed in the step (a) and an image data processed in the step (b) to the multimedia application processing module; and (d) the multimedia application processing module storing the image data processed in the step (a) received from the image signal processing module into a memory and displaying the image data processed in the step (b) received from the image signal processing module on the display means.

To achieve the above-mentioned objects, the present invention provides a computer readable medium stored thereon computer executable instructions for performing the above-mentioned image processing method.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a block diagram illustrating an image processing apparatus according to a preferred embodiment of the present invention.

FIG. 2 is a detailed block diagram illustrating an image signal processing module of FIG. 1 according to a preferred embodiment of the present invention.

FIG. 3 is a detailed block diagram illustrating an image signal processing module of FIG. 1 according to another embodiment of the present invention.

FIG. 4 is a detailed block diagram illustrating an image signal processing module of FIG. 1 according to still another embodiment of the present invention.

FIG. 5 is a schematic block diagram illustrating a communication interface between an image signal processing module according to yet another embodiment of the present invention and a multimedia application processing module.

FIG. 6 is a flow chart illustrating an image processing method according to a preferred embodiment of the present invention.

FIG. 7 is a flow chart illustrating an image processing method according to another embodiment of the present invention.

FIG. 8 is a flow chart illustrating an image processing method according to still another embodiment of the present invention.

FIG. 9 is a timing diagram illustrating a step for transmitting an image data according to a preferred embodiment of the present invention.

FIG. 10 is a timing diagram illustrating a step for transmitting an image data according to another embodiment of the present invention.

FIG. 11 is a timing diagram illustrating a step for transmitting an image data according to still another embodiment of the present invention.

FIG. 12 is a flow chart illustrating an image processing method in a continuous capture mode according to a preferred embodiment of the present invention.

FIG. 13 is a flow chart illustrating an image processing method in a continuous capture mode according to another embodiment of the present invention.

### DETAILED DESCRIPTION

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

An image processing apparatus according to the present invention is mounted in various digital photographing apparatuses. Here, the digital photographing apparatus may include a digital camera, a digital camcorder, a mobile phone having a digital camera, a PDA having a digital camera or a personal multimedia player having a digital camera, and is configured to obtain an image of an object by a user's operation of a shutter, convert the image into a digital image and store the digital image into a storage medium.

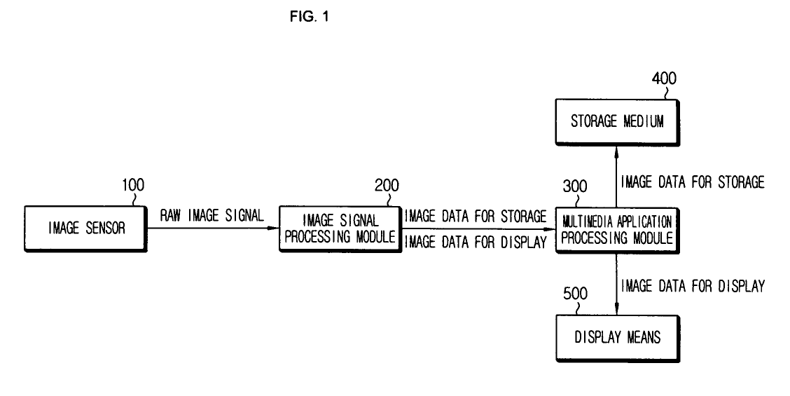

FIG. 1 is a block diagram illustrating an image processing apparatus according to a preferred embodiment of the present invention.

Referring to FIG. 1, the image processing apparatus according to a preferred embodiment of the present invention comprises an image sensor 100, an image signal processing module 200, a multimedia application processing module 300, a storage medium 400 and a display means 500.

The image sensor 100 picks up an image of an object and outputs an analog raw image signal to the image signal processing module 200. Preferably, the image sensor 100 is an image pickup device such as CCD or CMOS. However, the present invention is not limited to a specific type of image sensor.

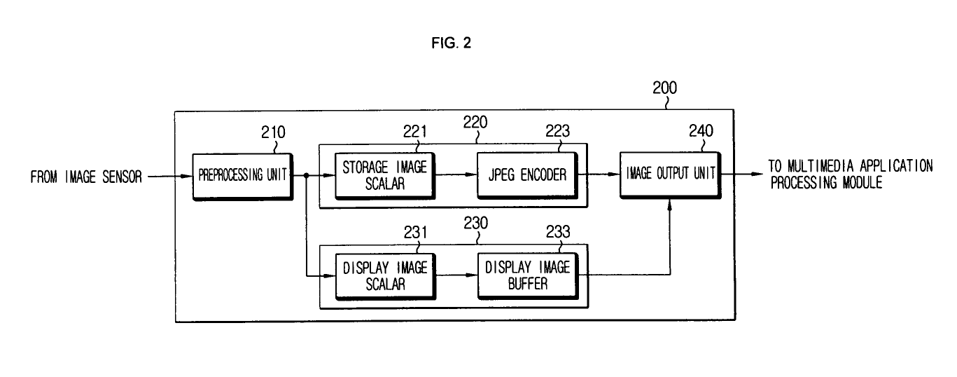

The image signal processing module 200 receives the analog raw image signal outputted from the image sensor 100, converts the received analog raw image signal into a digital image signal, processes the converted digital image signal according to the present invention, and outputs the processed digital image signal to the multimedia application processing module 300. Specifically, as shown in FIG. 2, the image signal processing module 200 according to this embodiment includes a preprocessing unit 210, an original image processing unit 220, a display image processing unit 230 and an image output unit 240.

The preprocessing unit 210 converts the analog raw image signal into a digital image signal, and if necessary, converts a color coordinate of the signal such as YUV or RGB, and the preprocessing unit 210 performs a typical image signal processing, for example color correction, gamma correction or noise reduction. Here, ‘preprocessing’ is commonly referred to as processing performed before storage image processing and display image processing according to the present invention. The processing performed by the preprocessing unit 210 is not directly related to features of the present invention, and is performed by a typical image signal processing module known widely as ISP (Image Signal Processor) in the related industry, and its detailed description is omitted.

The original image processing unit 220 is a function block configured to process the captured image that is captured by the image sensor 100 and preprocessed by the preprocessing unit 210, in conformity with format of a general image data to be stored into the storage medium 400 by the multimedia application processing module 300 to be described below.

Specifically, the original image processing unit 220 includes a storage image scalar 221. The storage image scalar 221 scales the captured image preprocessed by the preprocessing unit 210 in conformity with standard definition (for example, 640*480) preset by a user or set as a default by a photographing apparatus.

And, the original image processing unit 220 may include a JPEG encoder 223 for encoding the captured image scaled by the storage image scalar 221. The JPEG encoder 223 is not provided in the multimedia application processing module 300, but in the image signal processing module 200, and thus the image data to be stored in the storage medium 400 is encoded by the image signal processing module 200 and transmitted to the multimedia application processing module 300. Accordingly, a data rate is reduced to stabilize a data interface between the image signal processing module 200 and the multimedia application processing module 300. Meanwhile, although this embodiment shows encoding according to JPEG standard, the present invention is not limited to JPEG encoding.

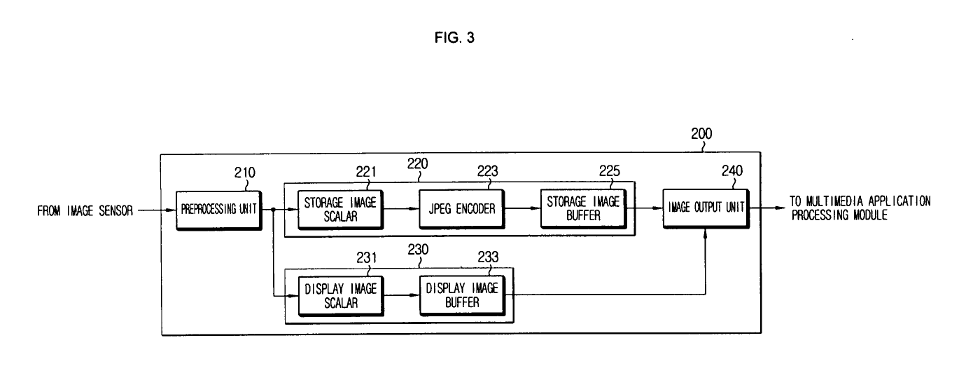

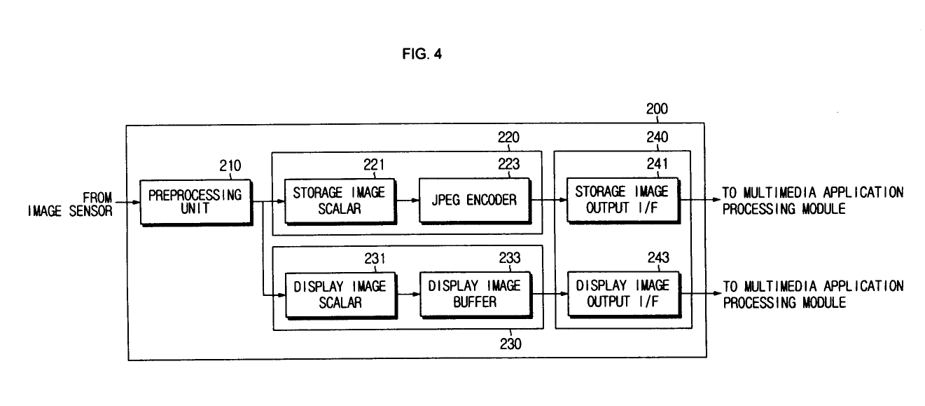

Further, as shown in FIG. 3, the original image processing unit 220 may include a storage image buffer 225 for temporarily storing the encoded image data. As shown in FIG. 4, the image output unit 240 may include, as a data streaming interface, a storage image output interface 241 and a display image output interface 243.

The display image processing unit 230 is a function block configured to process the captured image that is captured by the image sensor 100 and preprocessed by the preprocessing unit 210, in conformity with format of an image data to be displayed on the display means 500 by the multimedia application processing module 300 to be described below.

Specifically, the display image processing unit 230 includes a display image scalar 231 and a display image buffer 233. The display image scalar 231 scales the captured image preprocessed by the preprocessing unit 210 in conformity with a size (for example, 320*240) of the display means 500 that is incorporated as a view finder of a photographing apparatus. The display image buffer 233 temporarily stores the image data scaled by the display image scalar 231.

As shown in FIG. 3, sizes of the storage image buffer 225 and the display image buffer 233 are smaller than the whole sizes of image data for storage and image data for display, respectively, and each has such a size as to store an amount of data to be outputted in one time. The storage image buffer 225 and the display image buffer 233 each has a FIFO (First In First Out) structure.

Meanwhile, the display image processing unit 230 may further include an encoder (not shown)(for example, a JPEG encoder) for encoding the image data scaled by the display image scalar 231. In this case, the image data for display is encoded and transmitted to the multimedia application processing module 300 together with the above-mentioned image data for storage, so that a data interface between the image signal processing module 200 and the multimedia application processing module 300 can be further stabilized.

The image output unit 240 outputs the image data for storage encoded by the JPEG encoder 223 of the original image processing unit 220 and the image data for display scaled (or scaled and encoded) by the display image scalar 231, to the multimedia application processing module 300. At this time, the image data for storage and the image data for display may be outputted using various output methods, for example a sequential output method, an interleaving output method or a parallel output method, and its detailed description is made below.

Referring to FIG. 1, the multimedia application processing module 300 receives the image data for storage and the image data for display from the image signal processing module 200 (in practice, from the image output unit 240), and stores the image data for storage into the storage medium 400 such as SDRAM and the image data for display on the display means 500 having an LCD module, for example.

And, as shown in FIG. 3, the multimedia application processing module 300 receives the image data for storage and the image data for display for each predetermined unit from the image signal processing module 200 (in practice, from the image output unit 240), and stores the image data for storage into a storage image storing area and the image data for display into a display image storing area. Here, the storage image storing area and the display image storing area may be provided in the multimedia application processing module 300 or the storage medium 400 such as SDRAM.

And, when the image data for display stored in the display image storing area is enough for a single captured image, the multimedia application processing module 300 displays the image data for display on the display means 500 having an LCD module, for example.

Meanwhile, as shown in FIG. 4, the storage image output interface 241 according to still another preferred embodiment of the present invention outputs the image data for storage that is encoded by the JPEG encoder 223 of the original image processing unit 220, to the multimedia application processing module 300. And, the display image output interface 243 outputs the image data for display that is scaled (or scaled and encoded) by the display image scalar 231, to the multimedia application processing module 300. The storage image output interface 241 and the display image output interface 243 are independent data streaming interfaces from each other, and they may form the image output unit 240.

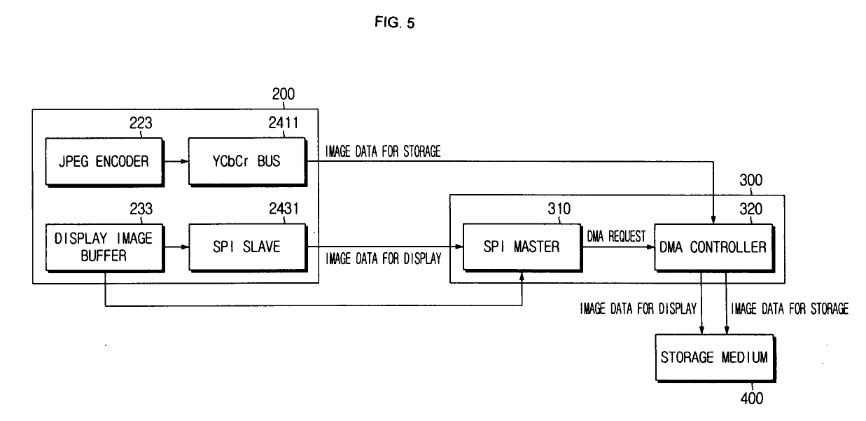

Specifically, referring to FIG. 5, the storage image output interface 241 may be incorporated into a YCbCr 8 bit bus 2411. And, the display image output interface 243 may be incorporated into a SPI (Serial Peripheral Interface) interface including a SPI master 310 and a SPI slave 2431. However, the present invention is not limited in this regard, and may use another interface that is well known to an ordinary person skilled in the art.

And, referring to FIG. 5, for rapid storage and reading of the image data, the multimedia application processing module 300 may allow data sending and receiving between the storage medium 400, the display means 500 and the multimedia application processing module 300 by a DMA (Direct Memory Access) method using a DAM controller 320.

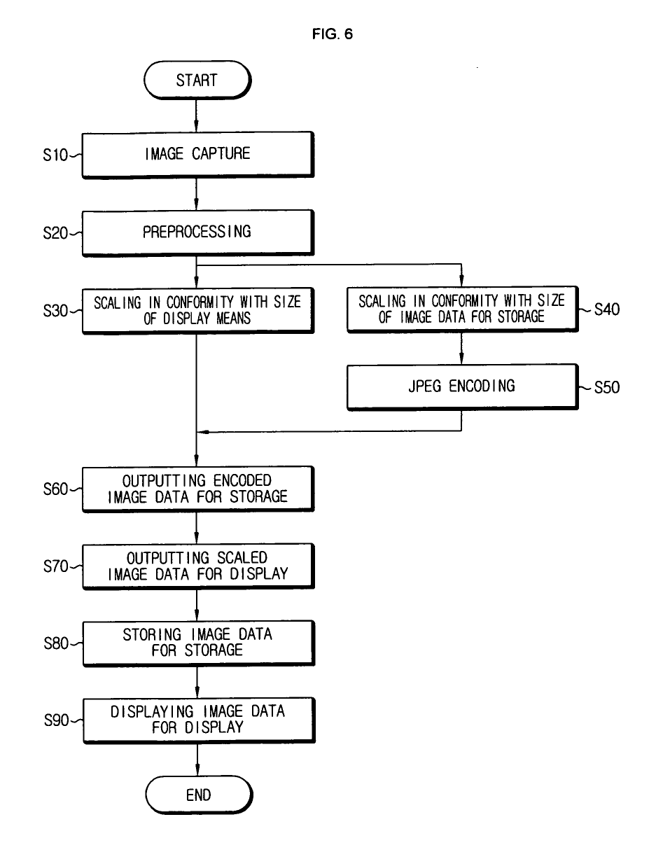

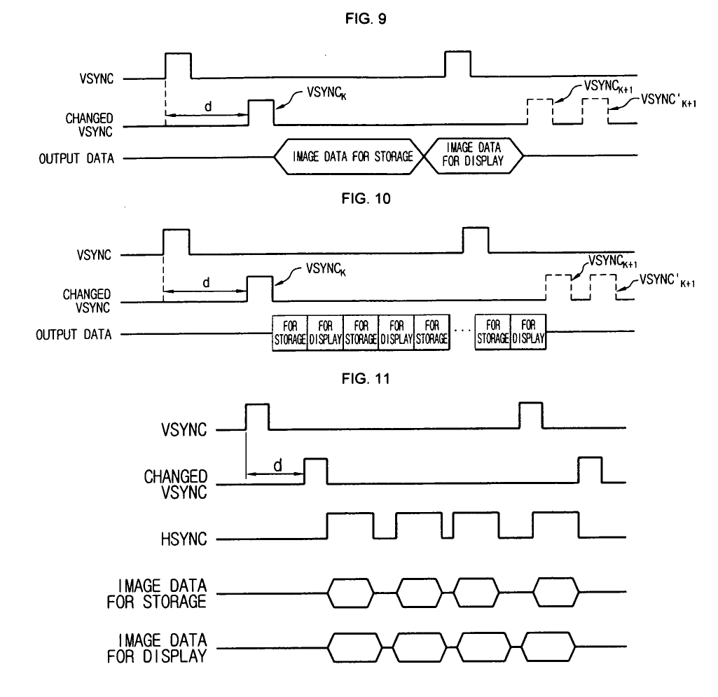

FIG. 6 is a flow chart illustrating an image processing method according to a preferred embodiment of the present invention. FIG. 9 is a timing diagram illustrating a step for transmitting an image data according to a preferred embodiment of the present invention. An image processing method according to an embodiment of the present invention is described in detail with reference to FIGS. 6 and 9.

Unlike a conventional camera, a commercial digital photographing apparatus supports a preview function for previewing an image of an object to be included in a picture through a view finder. That is, when a user turns on a digital photographing apparatus (or operates a digital photographing apparatus in a camera mode), the photographing apparatus enters a preview mode and displays an image of an object through a view finder in the form of a moving image that images are changed at a short frame interval. Then, when the user catches his/her desired optimum image, he/she operates a shutter to enter a capture mode and captures a digital still image of the object. The present invention relates to an image processing method in a capture mode, and an image processing method in a preview mode does not perform steps S40, S50, S60 and S80 of FIG. 6, but processes a preview image as an image for display, and displays the preview image on a display means. ‘VSYNC’ of FIG. 9 is a vertical synchronization signal representing a start of each frame. In a preview mode, the image data processing module 200 and the multimedia application processing module 300 are operated in synchronization with the VSYNC to process and display a preview image that is incorporated into each frame image.

Meanwhile, an image taken by the image sensor 100 in a preview mode or an image data processed by the image signal processing module 200 may be an image of a maximum size (definition) supported by the image sensor 100 or the photographing apparatus. However, as the photographing apparatus moves toward higher pixel, it takes more time to process a preview image. To solve the problem, a frame interval may be increased, which results in an unnatural moving image. Thus, it is typical to operate the image sensor 100 or the photographing apparatus in low definition although image quality is relatively low. On the other hand, an image captured in a capture mode is an image of a maximum size supported by the image sensor 100 or the photographing apparatus or an image of a size preset by the user. And, flash may be operated or an exposure time may be changed in the capture mode. As a result, an image displayed in a preview mode and an image captured in a capture mode may be different from each other.

When the user operates a shutter to enter a capture mode, the image sensor 100 captures an image of an object with a predetermined definition and outputs an analog raw image signal to the image signal processing module 200 (S10). Subsequently, the image signal processing module 200 processes the analog raw image signal. At this time, a time delay inevitably occurs to preprocessing and buffering until encoding of the JPEG encoder 223 begins and until the encoded image data for storage is outputted. Consequently, the multimedia application processing module 300 does not receive an image data for storage and an image data for display before a next vertical synchronization signal is inputted, with which the multimedia application processing module 300 is operated in synchronization, and the multimedia application processing module 300 may discard one frame. Accordingly, when an image is captured, a VSYNC signal is delayed as much as the delayed time (d), and the image signal processing module 200 and the multimedia application processing module 300 are operated in synchronization with the changed VSYNC signal.

Next, the preprocessing unit 210 of the image signal processing module 200 receives the analog raw image signal outputted from the image sensor 100 and performs the above-mentioned series of preprocessing, for example analog-digital conversion, color coordinate conversion, color correction, gamma correction or noise reduction (S20).

The image data preprocessed by the preprocessing unit 210 is inputted into the storage image scalar 221 of the original image processing unit 220 and the display image scalar 231 of the display image processing unit 230. Then, the display image scalar 231 scales the captured image preprocessed by the preprocessing unit 210 in conformity with a size (for example, 320*240) of the display means 500 of the photographing apparatus (S30), and temporarily stores the image data scaled by the display image scalar 231 into the display image buffer 233.

Meanwhile, the storage image scalar 221 scales the captured image preprocessed by the preprocessing unit 210 in conformity with definition standard (for example, 640*480) preset by the user or set as a default by the photographing apparatus (S40). Subsequently, the captured image scaled by the storage image scalar 221 is encoded by the JPEG encoder 223 (S50).

Next, the image output unit 240 outputs the image data for storage encoded by the JPEG encoder 223 and the image data for display scaled by the display image scalar 231 to the multimedia application processing module 300. At this time, the image data for storage and the image data for display may be outputted by various methods, however this embodiment shows a sequential output method. That is, the image output unit 240 outputs first the image data for storage from the JPEG encoder 223 (S60), and after output of the image data for storage is completed, the image output unit 240 reads the image data for display from the display image buffer 233 and outputs the image data for display to the multimedia application processing module 300 (S70). Here, an output order of the image data for storage and the image data for display may be changed. And, each of the image data for storage and the image data for display may have a variable or fixed length. In the case of fixed length, a dummy data may be added for length matching of the image data.

And, in the case that the image data for storage and the image data for display outputted by the image output unit 240 exceed one frame period, the image signal processing module 200 may skip or delay a vertical synchronization signal VSYNCₖ₊₁ representing a start of a next frame. In the case of delay, a dummy data may be added from an end of the outputted image data to a next vertical synchronization signal VSYNCₖ₊₂ or to the delayed vertical synchronization signal VSYNCₖ₊₁.

The multimedia application processing module 300 receives the image data for storage and the image data for display from the image output unit 240 as mentioned above, and stores the image data for storage into the storage medium 400, for example SDRAM (S80) and displays the image data for display on the display means 500 having an LCD module, for example (S90). Although this embodiment shows that the image data for display is not stored separately, however the image data for display may be stored into a predetermined storing area. Here, the storing area for storing the image data for display may be provided in the multimedia application processing module 300 or the storage medium 400. In the case that the image data for display is stored separately, it is useful in a continuous capture mode to be described below.

Meanwhile, as mentioned above, the display image processing unit 230 may further include an encoder (for example, JPEG encoder) for encoding the image data for display scaled by the display image scalar 231 or the display image processing unit 230 may encode the image data for display using the JPEG encode 223 of the original image processing unit 220. In the latter case, a data interface between the image signal processing module 200 and the multimedia application processing module 300 can be further stabilized. But, because the multimedia application processing module 300 should decode and display the encoded image data for display on the display means 500, it takes more time to display the encoded image data for display than an unencoded image data for display. However, typically a size of an image for display is much smaller than that of an image for storage, and thus it takes a short time to decode the image for display and the user feels a little time delay. The encoded data of the small-sized image for display may be used as a thumbnail image.

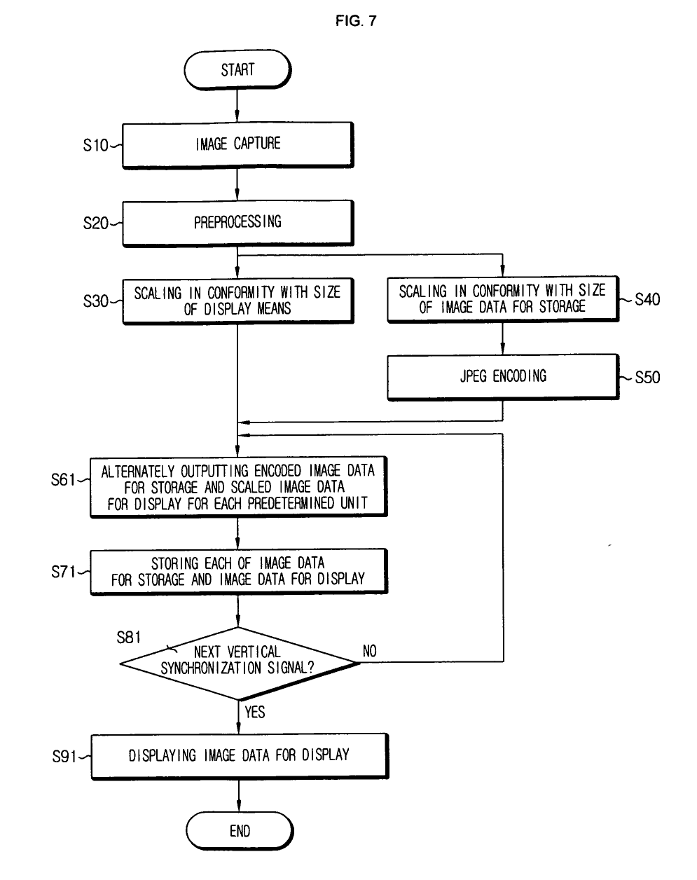

FIG. 7 is a flow chart illustrating an image processing method according to another embodiment of the present invention. FIG. 10 is a timing diagram illustrating a step for transmitting an image data according to another embodiment of the present invention. An image processing method according to another embodiment of the present invention is described in detail with reference to FIGS. 7 and 10, and the above-mentioned same step and overlapping description is omitted.

With steps S10 to S30, the storage image scalar 221 scales the captured image preprocessed by the preprocessing unit 210 in conformity with definition standard (for example, 640*480) preset by the user or set as a default by the photographing apparatus (S40). Subsequently, the captured image scaled by the storage image scalar 221 is encoded by the JPEG encoder 223 (S50), and the encoded image for storage is temporarily stored into the storage image buffer 225.

Next, the image output unit 240 outputs the image data for storage that is encoded by the JPEG encoder 223 and stored in the storage image buffer 225 and the image data for display that is scaled by the display image scalar 231 and stored in the display image buffer 233, to the multimedia application processing module 300. At this time, the image data for storage and the image data for display may be outputted by various methods, however this embodiment shows an interleaving output method, that is, the image data for storage and the image data for display is alternately outputted for each predetermined unit.

The interleaving output method may be incorporated such that the storage image buffer 225 and the display image buffer 233 occupy alternately an output bus of the image output unit 240. Specifically, when any one of the storage image buffer 225 and the display image buffer 233 is filled earlier with a predetermined critical amount of image data than the other buffer, the buffer occupies the output bus. Subsequently, the buffer sends a predetermined unit of image data and releases the output bus. This operation is performed alternately on the storage image buffer 225 and the display image buffer 233, so that the image data for storage and the image data for display are outputted alternately to the multimedia application processing module 300 for each predetermined unit (S61).

Here, in a strict sense, the image data may be not transmitted ‘alternately’. For example, according to size of the buffer or size of the image data, any one buffer may be filled with the image data more slowly than the other buffer. Then, the buffer may skip one transmission of image data.

Meanwhile, preferably, prior to loading its image data into the output bus, each buffer sends beforehand a header containing information representing whether the image data is an image data for storage or an image data for display, i.e. the type of the image data.

The multimedia application processing module 300 receives alternately the image data for storage and the image data for display for each predetermined unit as mentioned above, and stores the image data for storage into the storage image storing area and the image data for display on the display image storing area (S71). The above-mentioned header may be checked to determine whether the image data received from the image output unit 240 is an image data for storage or an image data for display.

The above-mentioned series of operations are performed continuously until a vertical synchronization signal VSYNCₖ₊₁ representing a start of a next frame is inputted (S81). When the next vertical synchronization signal VSYNCₖ₊₁ is inputted, the image data for display stored so far in the display image storing area are outputted to and displayed on the display means 500 (S91).

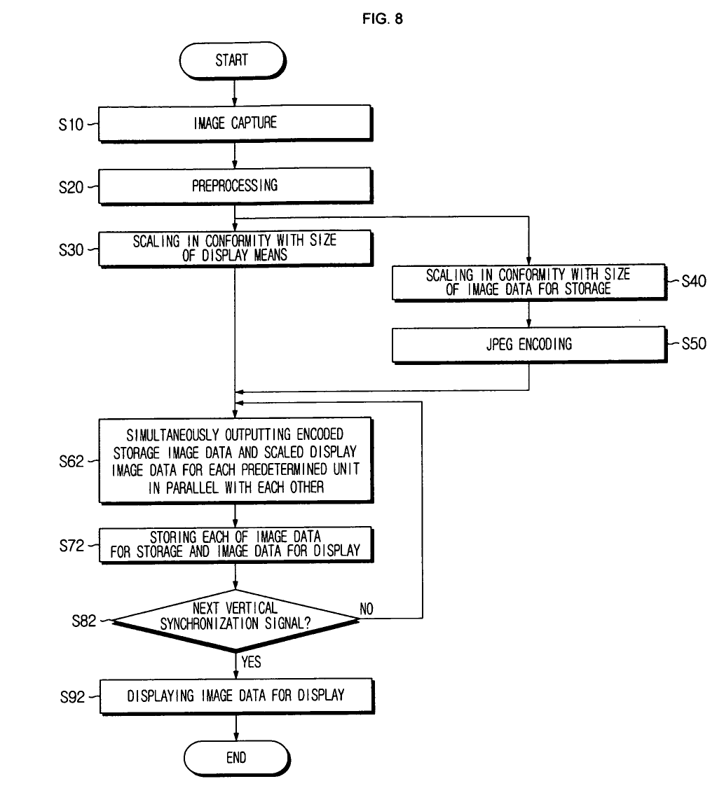

FIG. 8 is a flow chart illustrating an image processing method according to still another embodiment of the present invention. FIG. 11 is a timing diagram illustrating a step for transmitting an image data according to still another embodiment of the present invention. An image processing method according to still another embodiment of the present invention is described in detail with reference to FIGS. 8 and 11, and the above-mentioned same step and overlapping description is omitted.

With steps S10 to S30, the storage image scalar 221 scales the captured image preprocessed by the preprocessing unit 210 in conformity with definition standard (for example, 640*480) preset by the user or set as a default by the photographing apparatus (S40). Subsequently, the captured image scaled by the storage image scalar 221 is encoded by the JPEG encoder 223 (S50).

Next, the image output unit 240 outputs the image data for storage encoded by the JPEG encoder 223 and the image data for display scaled by the display image scalar 231 to the multimedia application processing module 300. At this time, the image data for storage and the image data for display may be outputted by various methods, however this embodiment shows a simultaneous parallel output method. That is, the image data for storage from the JPEG encoder 223 is outputted to the multimedia application processing module 300 using the storage image output interface 241, and in parallel with output of the image data for storage, the image data for display from the display image buffer 233 is outputted to the multimedia application processing module 300 using the display image output interface 243 (S62).

Specifically, the storage image output interface 241 is incorporated into a YCbCr 8 bit bus as mentioned above, and is configured to activate a horizontal synchronization signal HSYNC when loading the encoded image data for storage into the output bus, so that the multimedia application processing module 300 receives the image data for storage. And, the display image output interface 243 is incorporated into a SPI interface as mentioned above, and is configured to output an interrupt signal to the SPI master 310 when a predetermined amount of image data for display is gathered in the display image buffer 233. Then, the SPI master 310 receives the image data for display through the SPI slave 2431.

The multimedia application processing module 300 receives the image data for storage and the image data for display from the image output unit 240 as mentioned above, and stores the image data for storage into the storage image storing area of the storage medium 400, for example SDRAM and the image data for display into the display image storing area (S72). Next, it is determined whether or not a vertical synchronization signal VSYNCₖ₊₁ representing a start of a next frame is inputted (S82). In the case that the vertical synchronization signal VSYNCₖ₊₁ is not inputted, the method is returned to the step S60 to repeat the input and storage of the image data, and in the case that the vertical synchronization signal VSYNCₖ₊₁ is inputted, the image data for display stored in the display image storing area is displayed on the display means 500 having an LCD module, for example (S92).

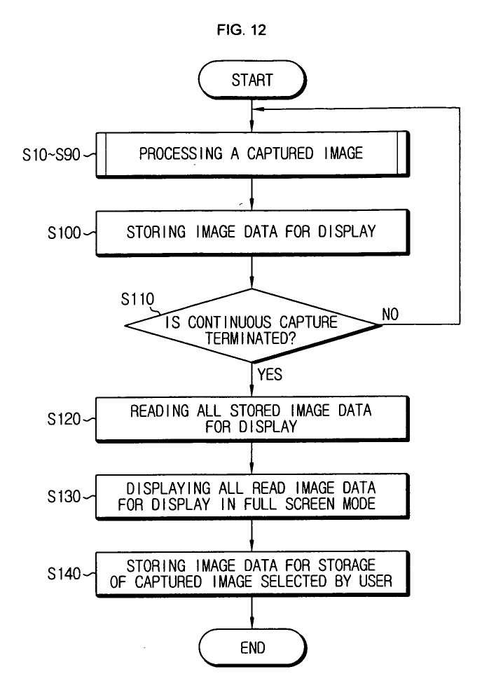

The above-mentioned description is related to a process for capturing and displaying one still image, however the present invention may be usefully applied to a continuous capture mode in which a plurality of images are captured continuously at a short time interval. The detailed description is made with reference to FIG. 12.

First, a process for capturing an image and displaying the captured image on a display means is performed in the same way as the steps S10 to S90 of FIG. 6. The process in a continuous capture mode further includes the following steps S100 to S140.

The image data for display is displayed on the display means (S90) and stored into the above-mentioned display image storing area (S100).

Next, judgment is made whether or not a continuous capture was terminated, i.e. whether or not a predetermined frequency of image captures were all performed (S110). In the case that a continuous capture was not terminated, the step S100 for storing the image data for display is repeated in the step S10 for capturing an image. That is, each captured image is directly displayed on the display means 500, and thus a user can check immediately the continuous captured images and the image data for display is stored for the user's final selection.

Meanwhile, in the case that a continuous capture was terminated, the image data for display of continuous captured images stored in the display image storing area is all read (S120).

The read image data for display is first downscaled so that a plurality of images are displayed in a full screen form, and displayed on the display means 500 in a full screen form for the user's selection (S130).

Then, the user selects a desired captured image, and finally an image data for storage corresponding to the selected captured image is stored into the storage medium (S140).

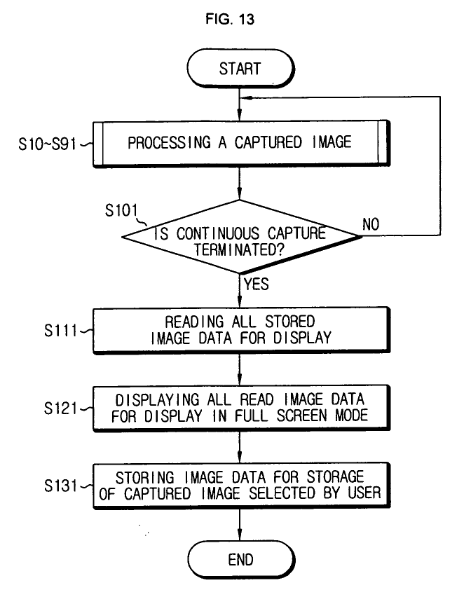

FIG. 13 is a flow chart illustrating an image processing method in a continuous capture mode according to another embodiment of the present invention. The image processing method in a continuous capture mode according to another embodiment of the present invention is described with reference to FIG. 13.

First, a process for capturing an image and displaying the captured image on a display means is performed in the same way as the steps S10 to S91 of FIG. 7. The process in a continuous capture mode further includes the following steps S101 to S131.

After processing of one captured image is completed, judgment is made whether or not a continuous capture was terminated, i.e. whether or not a predetermined frequency of image captures were all performed (S101). Consequently, in the case that a continuous capture was not terminated, the step S91 for displaying the image data for display is repeated in the step S10 for capturing an image. That is, each captured image is directly displayed on the display means 500, so that a user can check immediately the continuous captured images.

Meanwhile, in the case that a continuous capture was terminated, the image data for display of continuous captured images stored in the display image storing area is all read (S111).

The image data, read from the display image storing area, is first downscaled to a proper size so that a plurality of images can be displayed in a full screen form, and the images are displayed on the display means 500 in a full screen form for the user's selection (S121).

Then, the user selects a desired captured image, and finally an image data for storage corresponding to the selected captured image is stored into the storage medium (S131).

### SIMULATION EXAMPLE

Hereinafter, in the case that only an image data encoded from a captured image by an image signal processing module according to a conventional method is transmitted to a multimedia application processing module, a simulation example about the time taken to display the captured image is described to check the effect of the present invention.

This example uses an image sensor of three million pixels, and is performed to simulate the time taken between decoding of a file under the following conditions, into which the captured image is encoded according to JPEG standard, and output of the captured image to the display means.

ARM (Advanced RISC Machine) speed: 200 MHz

Cache size:. data cache RAM and code cache RAM each has a size of 16 KB

BUS speed: 100 MHz

A raw file size before three million pixel compression: 3M pixel×2=6 Mbytes (YCbCr 4:2:2, each pixel requires 2 bytes)

A file size after three million pixel compression: a compression rate is different depending on image, however because a typical compression rate is ¼ to ⅛, a file size after three million pixel compression is about 0.75 Mbytes to 1.5 Mbytes

It was found that the time taken to decode the JPEG file by the above-mentioned system was 600 ms (milliseconds) to the minimum. That is, conventionally it takes 600 ms or more to restore a compressed image of three million pixels for displaying the restored image on a display means, and thus a user feels unsatisfied with the capture time. However, the present invention displays an image data for display that is processed in conformity with format of a display means by the display image processing unit, on the display means as it is, and thus it does not require a time required to perform a separate operation for displaying a captured image, thereby resulting in a rapid display of the captured image.

The above-mentioned image processing method according to the present invention may be incorporated as a computer readable code in a computer readable medium. The computer readable medium includes all types of storage devices for storing data readable by a computer system. For example, the computer readable medium is ROM (Read Only Memory), RAM (Random Access Memory), CD-ROM (Compact Disc Read Only Memory), a magnetic tape, a floppy disc or an optical data storage device, and may be incorporated in the form of a carrier wave (for example, transmission via the Internet). And, the computer readable medium may store and execute a code that is dispersed in computer systems connected to each other via a network and is readable by a computer through a dispersion method. Further, function program, code and code segments for implementing the image processing method may be easily inferred by programmers in the prior art.

Only a few implementations and examples are described and other implementations, enhancements and variations can be made based on what is described and illustrated in this application.

According to the present invention, an image signal processing module outputs sequentially an image data for display and an image data for storage of a captured image to a multimedia application processing module, so that the multimedia application processing module stores the image data for storage into a memory and displays the image data for display on a display means. Because the image data for display is already processed in conformity with format of the display means by the image signal processing module, and in particular, the image data for display has a small size as to eliminate the need of a separate encoding, the multimedia application processing module does not require a separate decoding operation for displaying the captured image on the display means. Even if the decoding operation is required, the multimedia application processing module is capable of decoding a small sized image data in a short time. Therefore, the captured image is displayed without a significant time delay. And, according to the present invention, images captured continuously in a continuous capture mode are displayed directly, so that a user can rapidly check and select the images.

What is claimed is:

1. An image processing apparatus, comprising:
an image signal processing module including,
an original image processing unit for processing a captured image captured by an image sensor in conformity with a preset format of an image data for storage,
a display image processing unit for processing the captured image in conformity with format of a display means, and
an image output unit for outputting a first image data processed by the original image processing unit and a second image data processed by the display image processing unit; and
a multimedia application processing module for storing the first image data outputted from the image output unit into a memory and displaying the second image data outputted from the image output unit on the display means.

2. The image processing apparatus according to claim 1,
wherein the original image processing unit includes an encoding unit for encoding the captured image.

3. The image processing apparatus according to claim 1,
wherein the original image processing unit includes a storage image scalar for scaling the captured image in conformity with a preset size of an image data for storage.

4. The image processing apparatus according to claim 1,
wherein the display image processing unit includes a display image scalar for scaling the captured image in conformity with a size of the display means.

5. The image processing apparatus according to claim 1,
wherein the memory includes a storage image storing area and a display image storing area, and
wherein the multimedia application processing module stores the first image data into the storage image storing area and the second image data into the display image storing area.

6. The image processing apparatus according to claim 5,
where, in a continuous capture mode in which a capture operation of the image sensor is continuously performed, the multimedia application processing module:
stores continuously the first image data into the storage image storing area;
stores continuously the second image data into the display image storing area; and
displays continuously the second image data on the display means.

7. The image processing apparatus according to claim 6,
where, when a continuous capture in the continuous capture mode is completed, the multimedia application processing module reads and downscales all the image data stored continuously in the display image storing area, and displays the image data on the display means in a full screen mode.

8. The image processing apparatus according to claim 1,
where, in the case that the image data outputted by the image output unit exceeds one frame period, the image signal processing module skips or delays a vertical synchronization signal representing a start of a next frame.

9. The image processing apparatus according to claim 1,
wherein the image output unit outputs alternately the first image data and the second image data for each predetermined unit of image size, and
wherein the multimedia application processing module stores the first image data and the second image data outputted alternately from the image output unit into a storage image storing area and a display image storing area, respectively, and
when a signal representing a start of a next frame is inputted, the multimedia application processing module displays the second image data stored in the display image storing area on the display means.

10. The image processing apparatus according to claim 9,
wherein the original image processing unit includes:
a storage image scalar for scaling the captured image in conformity with a preset size of an image data for storage;
an encoding unit for encoding the captured image scaled by the storage image scalar; and
a storage image buffer for temporarily storing the captured image encoded by the encoding unit.

11. The image processing apparatus according to claim 9, wherein the display image processing unit includes:
a display image scalar for scaling the captured image in conformity with a size of the display means; and
a display image buffer for temporarily storing the captured image scaled by the display image scalar.

12. The image processing apparatus according to claim 1, wherein the image output unit of the image signal processing module includes:
a storage image output interface for outputting the first image data; and
a display image output interface for outputting the second image data.

13. The image processing apparatus according to claim 12, wherein the storage image output interface includes a YCbCr 8 bit bus as a data streaming interface.

14. The image processing apparatus according to claim 13, wherein the YCbCr 8 bit bus allows activation of data communication by a vertical synchronization signal.

15. The image processing apparatus according to claim 12, wherein the display image output interface includes an SPI (Serial Peripheral Interface) interface as a data streaming interface.

16. An image processing method comprising:
(a) processing a captured image captured by an image sensor in conformity with a preset format of an image data for storage;
(b) processing the captured image in conformity with format of a display means; and
(c) outputting a first image data, an image data processed in the step (a), and a second image data, an image data processed in the step (b); and
(d) storing the first image data into a memory and displaying the second image data on the display means.

17. The image processing method according to claim 16,
wherein the step (a) includes encoding the captured image.

18. The image processing method according to claim 16,
wherein the step (a) includes scaling the captured image in conformity with a preset size of an image data for storage.

19. The image processing method according to claim 16,
wherein the step (b) includes scaling the captured image in conformity with a size of the display means.

20. The image processing method according to claim 16,
wherein the step (d) includes storing the second image data into the memory.

21. The image processing method according to claim 20 where, in the case of a continuous capture mode,
the step (d) includes storing continuously the first image data into the memory and the second image data into the memory.

22. The image processing method according to claim 21,
wherein, when a continuous capture in the continuous capture mode is completed,
the step (d) includes reading and downscaling all the second image data stored continuously in the memory, and displaying the second image data on the display means in a full screen mode.

23. The image processing method according to claim 16 where, in the case that the outputted image data exceeds one frame period,
the step (c) includes skipping or delaying a vertical synchronization signal that represents a start of a next frame.

24. The image processing method according to claim 16,
wherein the step (c) includes outputting alternately the first image and the second image data, and
wherein the step (d) includes,
storing the second image data into a memory, and
displaying the second image data stored in the memory on the display means when a signal representing a start of a next frame is detected,.

25. The image processing method according to claim 24, wherein the step (a) includes:
(a1) scaling the captured image in conformity with a preset size of an image data for storage;
(a2) encoding the captured image scaled in the step (a1); and
(a3) storing the captured image encoded in the step (a2) into a storage image buffer.

26. The image processing method according to claim 25, wherein the step (b) includes:
(b1) scaling the captured image in conformity with a size of the display means; and
(b2) storing the captured image scaled in the step (b1) into a display image buffer.

27. The image processing method according to claim 26,
wherein the step (c) is performed such that, among the storage image buffer and the display image buffer, a buffer that is filled first with a predetermined unit of image data occupies an output bus to transmit the predetermined unit of image data.

28. The image processing method according to claim 27,
wherein the buffer occupying the output bus transmits a header containing information representing a type of image data to be transmitted, and wherein the step (d) includes,
detecting the type of image data from the information in the header, and
storing the image data into a memory according to the type detected.

29. The image processing method according to claim 16,
wherein the step (c) includes outputting the first image data and the second image data in parallel with each other, and
wherein the step (d) includes,
storing the second image data into a memory, and
displaying the second image data that was stored in the memory when a signal representing a start of a next frame is detected.

30. The image processing method according to claim 16,
wherein the step (c) includes outputting the first image data and the second image data using separate data streaming interfaces.

31. The image processing method according to claim 30,
wherein the step (c) includes outputting the first image data using a storage image output interface including a YCbCr 8 bit bus as a data streaming interface.

32. The image processing method according to claim 31,
wherein the YCbCr 8 bit bus allows activation of data communication by a vertical synchronization signal.

33. The image processing method according to claim 30,
wherein the step (c) includes outputting the second image data using a display image output interface including an SPI interface as a data streaming interface.

34. The image processing method according to claim 33, wherein the step (c) includes:
(c1) the display image output interface outputting an interrupt signal when a predetermined amount of the second image data is gathered; and
(c2) performing SPI communication to receive the second image data when the interrupt signal is received.

35. A computer readable medium stored thereon computer executable instructions for performing the method defined in claim 16.
